(19) United States
(12) Patent Application Publication
(10) Pub. No.: US 2020/0387396 A1
(43) Pub. Date: Dec. 10, 2020

(54) INFORMATION PROCESSING APPARATUS AND INFORMATION PROCESSING SYSTEM

(71) Applicant: FUJITSU CLIENT COMPUTING LIMITED, Kawasaki-shi (JP)

(72) Inventor: Yuki KAWAMA, Kawasaki (JP)

(21) Appl. No.: 16/853,787

(22) Filed: Apr. 21, 2020

(30) Foreign Application Priority Data
Jun. 5, 2019 (JP) 2019-104942

(51) Int. Cl. G06F 9/48; G06F 8/61; G06F 13/40

(52) U.S. Cl. CPC G06F 9/485; G06F 13/4027; G06F 8/61

(57) ABSTRACT

A storage section stores a first communication program that controls communication by a first communication section, a second communication program that controls communication by a second communication section, a first processing program and a second processing program that causes an associated communication program to transmit data on which a determined process has been performed, and correspondence information including a first identifier indicative of a first corresponding communication program associated with the first processing program and a second identifier indicative of a second corresponding communication program associated with the second processing program. A processing section determines the first corresponding communication program, sets in the correspondence information an identifier indicative of the determined first corresponding communication program as the first identifier, determines the second corresponding communication program, and sets in the correspondence information an identifier indicative of the determined second corresponding communication program as the second identifier.

### CROSS-REFERENCE TO RELATED APPLICATION

This application is based upon and claims the benefit of priority of the prior Japanese Patent Application No. 2019-104942, filed on Jun. 5, 2019, the entire contents of which are incorporated herein by reference.

### FIELD

The embodiments discussed herein are related to an information processing apparatus, an information processing system, and an information processing program.

### BACKGROUND

The technique of performing communication between a host personal computer (PC) and a processor connected to slots by a relay device by the use of an expansion bus, such as Peripheral Component Interconnect Express (PCIe) (registered trademark), in an information processing system including the host PC, the processor, and the relay device to which the host PC and the processor can be connected is developed.

See, for example, the following documents:

Japanese Laid-open Patent Publication No. 2008-41027, and

Japanese National Publication of International Patent Application No. 2012-504835

Such a host PC may make communication using an expansion bus, such as PCIe, a virtual local area network (LAN). In this case, the host PC uses a driver for performing communication by the use of an expansion bus, such as PCIe, and a driver for performing virtual LAN communication in combination. By doing so, the host PC makes communication between the host PC and a processor a virtual LAN using an expansion bus such as PCIe.

By the way, data traffic in a host PC may become heavy compared with the throughput of a bus interface (also referred to as a connection interface). Therefore, a host PC may be connected to a relay device by the use of a plurality of connection interfaces. To set up a virtual LAN using an expansion bus such as PCIe for making communication between the host PC and a processor via each of the plurality of connection interfaces, a pair of drivers are used in combination for each of the plurality of connection interfaces. Accordingly, the host PC installs as many pairs of a driver for performing communication by the use of an expansion bus, such as PCIe, and a driver for performing virtual LAN communication as the number of the connection interfaces.

If as many pairs of drivers for performing communication by the use of an expansion bus, such as PCIe, and for performing virtual LAN communication as the number of the connection interfaces are installed in this way and restart is performed, then a correspondence of the divers may become different from the one before the restart. In such a case, the following problem arises. If the host PC gives instructions based on the assumption of the original correspondence, then data is not outputted from a connection interface which the host PC expects. As a result, data are not properly distributed to each connection interface. This leads to deterioration in communication performance and a communication failure may occur.

### SUMMARY

According to an aspect, there is provided an information processing apparatus including a first communication device connected to another apparatus via an expansion bus so as to perform communication, a second communication device connected to said another apparatus via the expansion bus so as to perform communication, a memory which stores a first communication program that controls communication with said another apparatus by the first communication device via the expansion bus, a second communication program that controls communication with said another apparatus by the second communication device via the expansion bus, a first processing program and a second processing program that perform a determined process on data and that cause an associated one of the first communication program and the second communication program to transmit to said another apparatus the data on which the determined process has been performed, and correspondence information including a first identifier indicative of a first corresponding communication program, of the first communication program and the second communication program, associated with the first processing program and a second identifier indicative of a second corresponding communication program, of the first communication program and the second communication program, associated with the second processing program, and a processor which determines the first corresponding communication program from the first communication program and the second communication program, which sets in the correspondence information an identifier indicative of the determined first corresponding communication program as the first identifier, which determines the second corresponding communication program from the first communication program and the second communication program, and which sets in the correspondence information an identifier indicative of the determined second corresponding communication program as the second identifier.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are views for describing an example of an information processing apparatus according to a first embodiment;

FIG. 2 illustrates an example of an overall outline of an edge computing system according to a second embodiment;

FIG. 3 illustrates an example of a hardware configuration of an information processing system according to the second embodiment;

FIG. 4 illustrates an example of a hardware configuration of a platform according to the second embodiment;

FIG. 5 illustrates an example of a hardware configuration of a PCIe bridge controller in the second embodiment;

FIG. 6 illustrates an example of software configurations of individual platforms in the information processing system according to the second embodiment;

FIG. 7 is a view for describing an example of a communication process performed between platforms in the information processing system according to the second embodiment;

FIG. 8 is a view for describing an example of a method for transferring data between processors via the PCIe bridge controller in the information processing system according to the second embodiment;

FIG. 9 illustrates an example of the functional structure of a platform in the second embodiment;

FIG. 10 is a view for describing a problem which arises in a case where a correspondence has changed in the second embodiment;

FIG. 11 illustrates an example of a process of setting parameter information at a time of installation in the second embodiment; and

FIG. 12 illustrates an example of a process of setting parameter information at a time of start in the second embodiment.

### DESCRIPTION OF EMBODIMENTS

Embodiments will now be described with reference to the accompanying drawings.

### First Embodiment

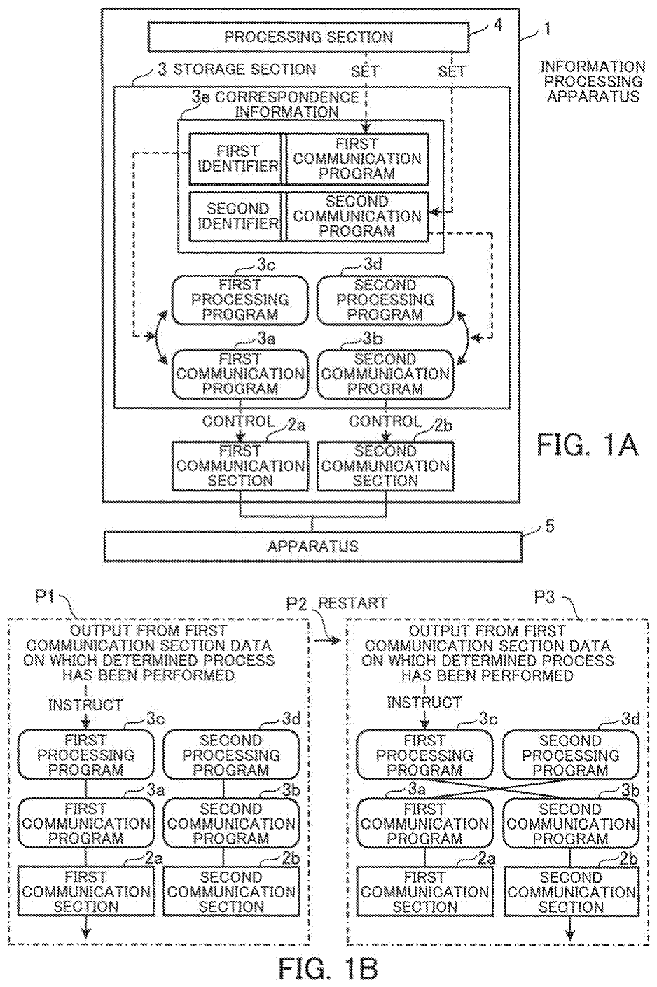

FIGS. 1A and 1B are views for describing an example of an information processing apparatus according to a first embodiment. An information processing apparatus 1 illustrated in FIG. 1A includes a first communication section 2a, a second communication section 2b, a storage section 3, and a processing section 4.

For example, each of the first communication section 2a and the second communication section 2b is realized by a connection interface (also referred to as a communication interface or a bus interface), such as a PCIe interface, included in the information processing apparatus 1 for making a connection to an expansion bus. For example, the storage section 3 is realized by a storage device, such as a random access memory (RAM), included in the information processing apparatus 1. The storage section 3 may be a volatile storage device such as a RAM or a nonvolatile storage device such as a hard disk drive (HDD) or a flash memory. For example, the processing section 4 is realized by a processor, such as a central processing unit (CPU), included in the information processing apparatus 1. The processing section 4 may be a digital signal processor (DSP), an application specific integrated circuit (ASIC), a field programmable gate array (FPGA), or the like. The processing section 4 executes a program stored in a memory (for example, the storage section 3) such as a RAM. The “processor” may be a set of processors (multiprocessor).

Each of the first communication section 2a and the second communication section 2b is connected via an expansion bus to another apparatus 5 so as to perform communication. Communication for transmitting and receiving data between the information processing apparatus 1 and the apparatus 5 is performed via the first communication section 2a or the second communication section 2b.

The storage section 3 stores a first communication program 3a, a second communication program 3b, a first processing program 3c, a second processing program 3d, and correspondence information 3e. The first communication program 3a controls communication between the first communication section 2a and the apparatus 5 via the expansion bus. To be concrete, the first communication program 3a transmits data to and receives data from the apparatus 5 in accordance with a determined communication protocol (PCIe, for example). The second communication program 3b controls communication between the second communication section 2b and the apparatus 5 via the expansion bus. To be concrete, the second communication program 3b transmits data to and receives data from the apparatus 5 in accordance with a determined communication protocol.

Each of the first processing program 3c and the second processing program 3d performs a determined process on data and causes a corresponding communication program, the first communication program 3a or the second communication program 3b, to transmit the data on which the determined process has been performed to the apparatus 5. For example, the determined process includes encapsulating (encrypting, for example) the data so as to perform communication with the apparatus 5 by tunneling (by establishing a virtual direct (LAN) line).

That is to say, if a virtual direct line is not established, then the information processing apparatus 1 only uses a communication program (for example, the first communication program 3a or the second communication program 3b) for performing communication with the apparatus 5. On the other hand, if a virtual direct line is established, then the information processing apparatus 1 uses a processing program (for example, the first processing program 3c or the second processing program 3d) and a communication program with which the processing program is associated for performing communication with the apparatus 5.

The correspondence information 3e includes a first identifier and a second identifier. The first identifier indicates a first corresponding communication program, the first communication program 3a or the second communication program 3b, with which the first processing program 3c is associated. The second identifier indicates a second corresponding communication program, the first communication program 3a or the second communication program 3b, with which the second processing program 3d is associated.

In the example of FIG. 1A, an identifier indicative of the first communication program 3a is set as the first identifier, and the correspondence information 3e indicates that the first processing program 3c is associated with the first communication program 3a (that is to say, the first processing program 3c is paired with the first communication program 3a). Furthermore, an identifier indicative of the second communication program 3b is set as the second identifier, and the correspondence information 3e indicates that the second processing program 3d is associated with the second communication program 3b.

That is to say, the information processing apparatus 1 illustrated in FIG. 1A is configured to cause the first communication program 3a to transmit to the apparatus 5 data on which the first processing program 3c has performed the determined process. Furthermore, the information processing apparatus 1 illustrated in FIG. 1A is configured to cause the second communication program 3b to transmit to the apparatus 5 data on which the second processing program 3d has performed the determined process.

The processing section 4 determines from the first communication program 3a and the second communication program 3b the first corresponding communication program to be associated with the first processing program 3c. The processing section 4 sets in the correspondence information 3e an identifier indicative of the determined first corresponding communication program as the first identifier.

The processing section 4 determines from the first communication program 3a and the second communication program 3b the second corresponding communication program to be associated with the second processing program 3d. The processing section 4 sets in the correspondence information 3e an identifier indicative of the determined second corresponding communication program as the second identifier.

By setting the correspondence information 3e in this way, the information processing apparatus 1 fixes a communication program (for example, the first communication program 3a or the second communication program 3b) with which each processing program (for example, the first processing program 3c or the second processing program 3d) is associated. As a result, the information processing apparatus 1 prevents an unexpected change of a communication program with which a processing program is associated due to restart or the like.

As illustrated in FIG. 1B, for example, outputting from the first communication section 2a data on which the determined process has been performed may be realized by an application by giving instructions to the first processing program 3c (P1). In such a case, the following problem may arise. If the correspondence unexpectedly changes due to restart or the like (P2) and the application gives the same instructions as the application would have given before the restart, then the data on which the determined process has been performed is outputted from an unexpected communication section (the second communication section 2b, in this example) (P3).

If data on which the determined process has been performed is not outputted from the communication section as the application expects in this way, then the information processing apparatus 1 fails to properly perform resource management (distribution of a load caused by communication via each communication section, for example). For example, it is assumed that the load on the second communication section 2b is heavy after the restart. In such a case, the information processing apparatus 1 gives instructions, for the purpose of load distribution, to the first processing program 3c to transmit and receive data on which the determined process has been performed via the first communication section 2a. This may further lead to maldistribution of a load. As a result, communication performance deteriorates and a communication failure may occur.

With the information processing apparatus 1, on the other hand, a communication program with which each processing program is associated is fixed by holding the correspondence information 3e. As a result, there is no possibility that the correspondence might change due to restart or the like. Accordingly, with the information processing apparatus 1, deterioration in communication performance is prevented and the occurrence of a communication failure is prevented.

### Second Embodiment

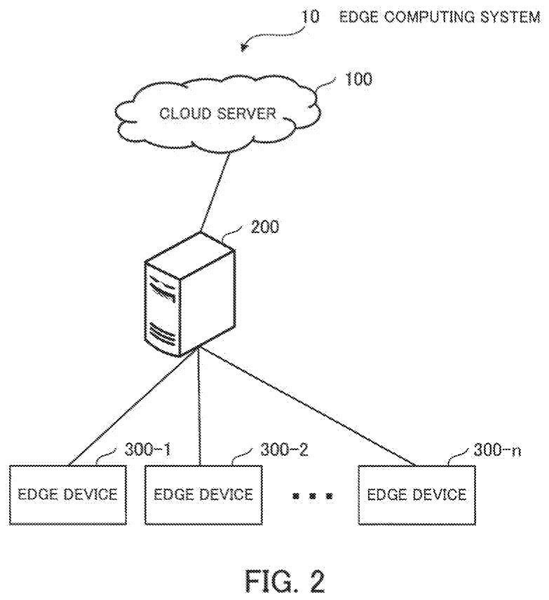

An edge computing system will now be described as a more concrete embodiment. FIG. 2 illustrates an example of an overall outline of an edge computing system according to a second embodiment.

An edge computing system 10 performs data processing in an area near an edge (or a front) where data is collected. By doing so, the edge computing system 10 realizes processing in which communication delay and the like are suppressed and in which a real-time property is ensured. For example, the edge computing system 10 is a system in a retail store or the like which performs person estimation by the use of artificial intelligence (AI) inference.

The edge computing system 10 includes a cloud server 100, an information processing system (for example, an edge computer) 200, and edge devices 300-1 through 300-n connected to one another so as to perform communication. Hereinafter an “edge device 300” will be used to indicate an arbitrary edge device of the edge devices 300-1 through 300-n.

An edge device 300 collects and outputs data and is located at an edge (that is to say, at a position near a user). The edge device 300 is a camera, a microphone, a speaker, or the like.

The information processing system 200 aggregates the data collected by the edge device 300 and processes aggregated data. The information processing system 200 is located in an area near the edge (that is to say, the edge device 300).

For example, the cloud server 100 generates and provides learning data used by the information processing system 200 for data processing. For example, the cloud server 100 is located in a data center.

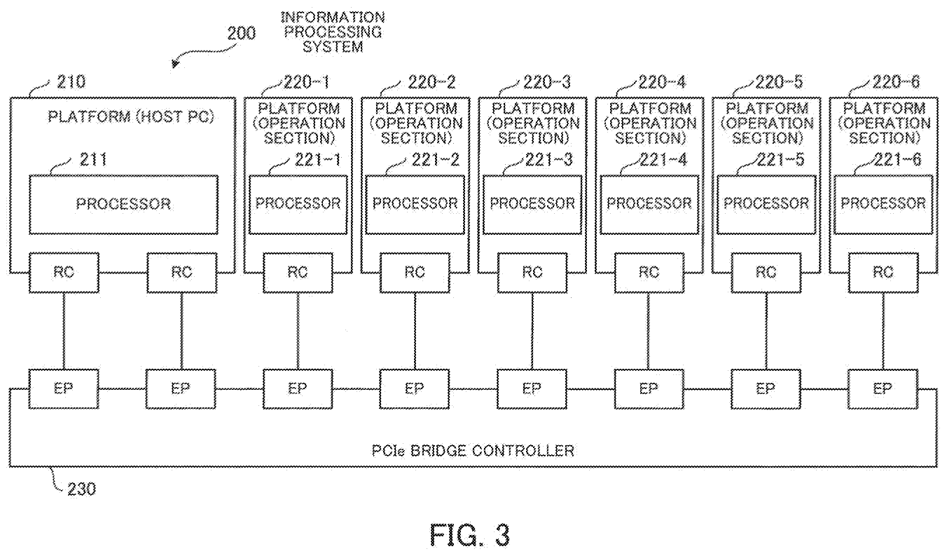

A hardware configuration of the information processing system 200 will now be described. FIG. 3 illustrates an example of a hardware configuration of the information processing system according to the second embodiment.

The information processing system 200 illustrated in FIG. 3 includes a PCIe bridge controller (also referred to as a relay device) 230 and platforms 210 and 220-1 through 220-6. The platform 210 is an example of the information processing apparatus 1 according to the first embodiment. The platform 210 is a host PC which functions as a control section and a graphical user interface (GUI) of the information processing system 200. Each of the platforms 220-1 through 220-6 is an operation section which performs AI inference processing, image processing, and the like. The platforms 210 and 220-1 through 220-6 may be different from one another. Hereinafter a numeral will not be used to indicate an arbitrary platform of the platforms 210 and 220-1 through 220-6.

A platform is connected to the PCIe bridge controller 230 so as to perform communication. To be concrete, the platform 210 is connected to two end points (EPs) mounted in the PCIe bridge controller 230 by using two root complexes (RCs) (for example, by causing two PCIe interfaces (also referred to as connecting portions) to function as the RCs). Each EP is a connecting portion on the slave side recognized as a terminal device of an expansion bus. Each RC is a connecting portion on the master side which recognizes an EP as a terminal device and which controls communication via the expansion bus.

The platform 210 functions as a host PC and it is expected that the amount of data transmitted and received becomes large. Accordingly, the platform 210 is connected to the PCIe bridge controller 230 by the use of the two RCs. Because the two RCs are connected in this way to the two EPs, the platform 210 is capable of wideband communication by properly distributing data communication paths (that is to say, by determining which of the paths between the RCs and the EPs to use for communication).

Each of the platforms 220-1 through 220-6 is connected by the use of one RC to one EP mounted in the PCIe bridge controller 230.

With the information processing system 200, as stated above, the platform is an RC which operates as the host side, the PCIe bridge controller 230 is an EP, and data transfer is performed.

The platform 210 includes a processor 211. The platforms 220-1 through 220-6 include processors 221-1 through 221-6 respectively. Hereinafter a numeral will not be used to indicate an arbitrary processor of the processors 211 and 221-1 through 221-6.

The processors may be provided by different manufacturers (or vendors). For example, the processor 211 may be provided by A company, the processor 221-1 may be provided by B company, the processor 221-2 may be provided by C company, and the processor 221-3 may be provided by D company. Furthermore, the processor 221-4 may be provided by E company, the processor 221-5 may be provided by F company, and the processor 221-6 may be provided by G company.

The processor overall controls a platform in which it is mounted. The processor may be a multiprocessor. The processor is a CPU, a micro processing unit (MPU), a DSP, an ASIC, a programmable logic device (PLD), or the like.

Furthermore, the processor may be a combination of two or more of a CPU, a graphics processing unit (GPU), an MPU, a DSP, an ASIC, and a PLD.

The PCIe bridge controller 230 includes an expansion bus (for example, a bus which functions as an expansion bus of each platform) and relays communication via the expansion bus.

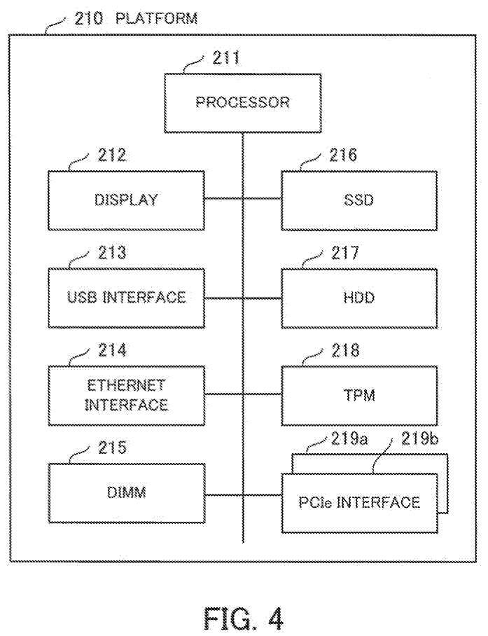

A hardware configuration of the platform will now be described. FIG. 4 illustrates an example of a hardware configuration of the platform according to the second embodiment.

The platform 210 includes the processor 211, a display 212, a universal serial bus (USB) interface 213, an Ethernet (registered trademark) interface 214, and a dual inline memory module (DIMM) 215. Furthermore, the platform 210 includes a solid state drive (SSD) 216, an HDD 217, a trusted platform module (TPM) 218, and PCIe interfaces 219a and 219b. The components included in the platform 210 are connected via a bus to one another.

The processor 211 controls the whole of the platform 210 overall. The display 212 functions as a display unit which displays various pieces of information. A USB device is connected to the USB interface 213 and the USB interface 213 serves as a medium of communication between the USB device and the processor 211. An Ethernet cable is connected to the Ethernet interface 214 and the Ethernet interface 214 serves as a medium of communication between an external device and the processor 211 via the Ethernet cable.

The DIMM 215 is a volatile storage medium, such as a RAM, which temporarily stores various pieces of information. Each of the SSD 216 and the HDD 217 is a nonvolatile storage medium which stores various pieces of information even after a shutoff of power supply. Each of the SSD 216 and the HDD 217 stores various pieces of information such as various programs executed by the processor 211. The TPM 218 realizes the security function of the system. Each of the PCIe interfaces 219a and 219b is a communication interface (that is to say, a connection interface) for making a connection to the expansion bus. With the information processing system 200, each of the PCIe interfaces 219a and 219b is connected to the PCIe bridge controller 230 and serves as a medium of communication between the platform 210 and the platforms 220-1 through 220-6 via the PCIe bridge controller 230. Hereinafter a “PCIe interface 219” will be used to indicate an arbitrary PCIe interface of the PCIe interfaces 219a and 219b.

The processing functions of the platform 210 are realized by adopting the above hardware configuration.

Processing functions performed by each of the platforms 220-1 through 220-6 are realized by adopting the same hardware configuration. Hereinafter it is assumed that the same hardware configuration is adopted for the platforms 220-1 through 220-6. The above components except the processors of the platforms 220-1 through 220-6 will be indicated by the use of the same numerals as described above.

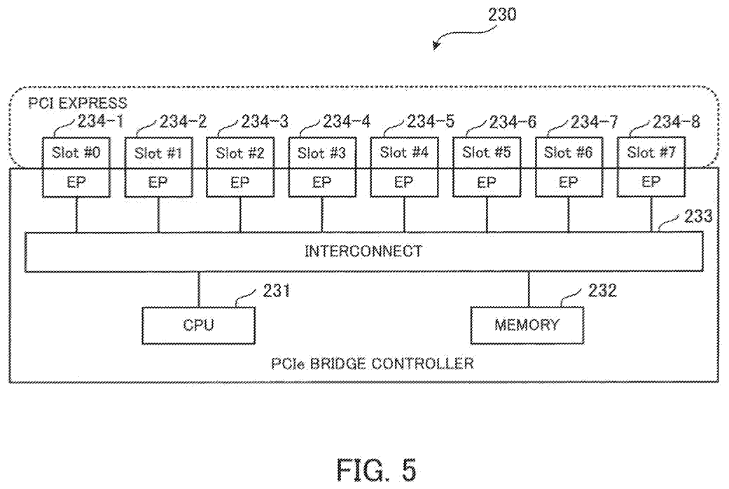

A hardware configuration of the PCIe bridge controller 230 will now be described. FIG. 5 illustrates an example of a hardware configuration of the PCIe bridge controller in the second embodiment.

The PCIe bridge controller 230 is a relay device which includes on one chip a connection interface that functions as an 8-channel EP. The PCIe bridge controller 230 includes a CPU 231, a memory 232, an interconnect 233, and slots (that is to say, connection interfaces) 234-1 through 234-8. Hereinafter a “slot 234” will be used to indicate an arbitrary slot of the slots 234-1 through 234-8.

A device configured to meet the PCIe standard is connected to each of the slots 234-1 through 234-8. With the information processing system 200, the platform 210 is connected to the slots 234-1 and 234-2 and the platforms 220-1 through 220-6 are connected to the slots 234-3 through 234-8 respectively. The platform 210 performs wideband communication by using two slots 234 assigned in this way to the platform 210.

Hereinafter it is assumed that the PCIe interface 219a of the platform 210 is connected to Slot #0 and that the PCIe interface 219b of the platform 210 is connected to Slot #1. Furthermore, it is assumed that the platform 220-1 is connected to Slot #2, that the platform 220-2 is connected to Slot #3, and that the platform 220-3 is connected to Slot #4. Moreover, it is assumed that the platform 220-4 is connected to Slot #5, that the platform 220-5 is connected to Slot #6, and that the platform 220-6 is connected to Slot #7.

Each slot 234 is connected via an internal bus to the interconnect 233. Furthermore, the CPU 231 and the memory 232 are connected to the interconnect 233. As a result, each slot 234, the CPU 231, and the memory 232 are connected via the interconnect 233 to one another so as to perform communication.

For example, the memory 232 is a storage memory (physical memory) including a read only memory (ROM) and a RAM. A software program related to data communication control and data and the like for this program are written to the ROM of the memory 232. A software program in the memory 232 is read into the CPU 231 and is executed. Furthermore, the RAM of the memory 232 is used as a primary storage memory or a working memory.

The CPU 231 controls the whole of the PCIe bridge controller 230. The CPU 231 may be a multiprocessor. One of an MPU, a DSP, an ASIC, a PLD, and an FPGA may be used in place of the CPU 231. Furthermore, the CPU 231 may be a combination of two or more of a CPU, an MPU, a DSP, an ASIC, a PLD, and an FPGA.

The CPU 231 executes a software program stored in the memory 232. By doing so, data transfer (that is to say, data transmission and reception) between platforms (or processors) is realized in the PCIe bridge controller 230.

The PCIe bridge controller 230 uses PCIe for carrying out high-speed data transfer between platforms, makes a processor included in each platform operate as an RC, and realizes data transfer between EPs which operate as a device.

To be concrete, in the information processing system 200, a processor included in each platform operates as an RC of PCIe, which is a data transfer interface.

Furthermore, the PCIe bridge controller 230 (for example, a slot 234 to which each platform is connected) operates as an EP with respect to each platform (or each processor).

Connecting the PCIe bridge controller 230 to a processor as an EP is realized by various known methods.

For example, when the PCIe bridge controller 230 is connected to a platform, the PCIe bridge controller 230 informs the processor concerned of a signal which is indicative that it functions as an EP. By doing so, the PCIe bridge controller 230 is connected to the processor as an EP.

The PCIe bridge controller 230 transfers data to a plurality of RCs by tunneling data by an end-point-to-end-point (EP-to-EP) connection. Communication between processors is logically established when a PCIe transaction occurs. When data transfers are not concentrated at one processor, data transfers may be performed in parallel between processors.

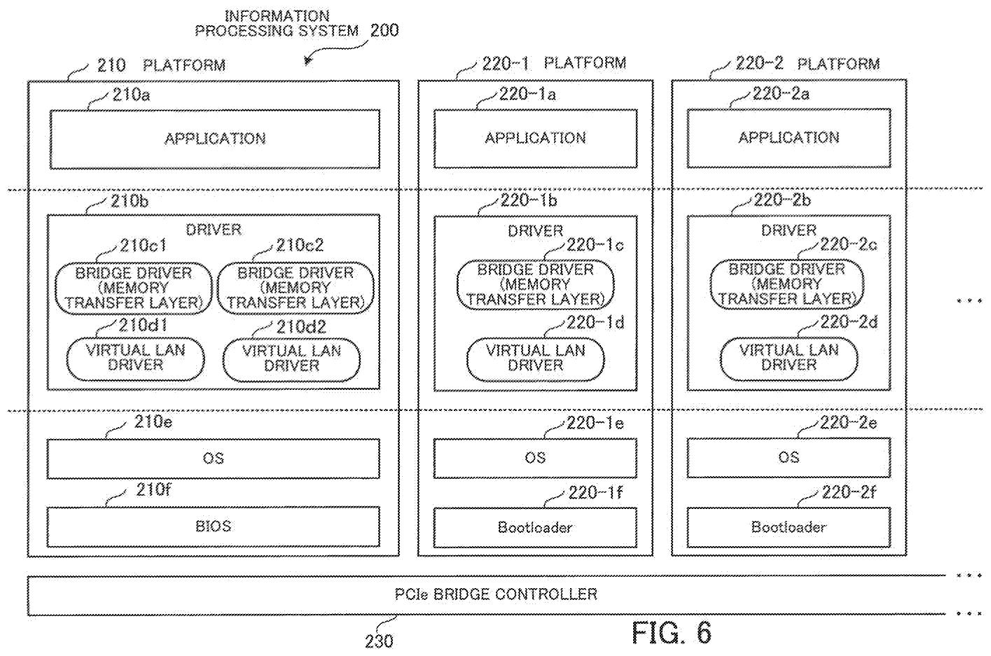

A software configuration of the information processing system 200 will now be described by the use of FIG. 6. FIG. 6 illustrates an example of software configurations of individual platforms in the information processing system according to the second embodiment. For convenience, FIG. 6 illustrates software configurations of only the platforms 210, 220-1, and 220-2. Software configurations of the platforms 220-1 through 220-6 are the same.

First, the platform 210 will be described. The platform 210 includes an application 210a, a driver 210b, an operating system (OS) 210e, and a basic input output system (BIOS) 210f.

The application 210a is application software or an application program which performs various processes on the platform 210 by exploiting functions provided by the OS 210e. The application 210a operates on the OS 210e. The platform 210 performs various processes under the control of the application 210a.

The driver 210b is software prepared so that the OS 210e is able to control hardware and the like mounted in the platform 210.

The driver 210b included in the platform 210 includes bridge drivers 210c1 and 210c2, virtual LAN drivers 210d1 and 210d2, and the like. The bridge drivers 210c1 and 210c2 are examples of the first communication program 3a and the second communication program 3b in the first embodiment.

The virtual LAN drivers 210d1 and 210d2 are examples of the first processing program 3c and the second processing program 3d in the first embodiment. Hereinafter a “bridge driver 210c” will be used to indicate an arbitrary bridge driver of the bridge drivers 210c1 and 210c2. Furthermore, hereinafter a “virtual LAN driver 210d” will be used to indicate an arbitrary virtual LAN driver of the virtual LAN drivers 210d1 and 210d2.

A bridge driver 210c controls the PCIe bridge controller 230 (in other words, a bridge driver 210c electrically accesses the PCIe bridge controller 230 to perform communication with another platform.

The platform 210 is connected to the two EPs mounted in the PCIe bridge controller 230 by the use of the two RCs. Accordingly, the platform 210 includes two bridge drivers 210c corresponding to the two RCs.

Hereinafter, it is assumed that the bridge driver 210c1 corresponds to the PCIe interface 219a and that the bridge driver 210c2 corresponds to the PCIe interface 219b.

A virtual LAN driver 210d is used in combination with a bridge driver 210c to perform communication with another platform through a virtual LAN line established by tunneling.

The platform 210 is connected to the two EPs mounted in the PCIe bridge controller 230 by the use of the two RCs. Accordingly, the platform 210 includes two virtual LAN drivers 210d for enabling communication using the two RCs to be virtual LAN communication.

For example, in order to increase security, the platform 210 performs virtual LAN communication with another platform by the use of a virtual LAN driver 210d and a bridge driver 210c. If there is no need to increase security, then the platform 210 performs communication with another platform by the use of only a bridge driver 210c.

The OS 210e is basic software or a basic program for operating the platform 210. The BIOS 210f is software for controlling the start of the OS 210e on the platform 210. On the platform 210, for example, a bootloader is started (or invoked) by the BIOS 210f, the OS 210e is detected by the bootloader started by the BIOS 210f, and the OS 210e starts.

The platforms 220-1 through 220-6 will now be described. Because the configurations of the platforms 220-1 through 220-6 are the same, the platform 220-1 will be described as an example. The platform 220-1 includes an application 220-1a, a driver 220-1b, an OS 220-1e, and a bootloader 220-1f.

The application 220-1a is application software or an application program which performs various processes on the platform 220-1 by exploiting functions provided by the OS 220-1e. The application 220-1a operates on the OS 220-1e. The platform 220-1 performs various processes under the control of the application 220-1a.

The driver 220-1b is software prepared such that the OS 220-1e is able to control hardware and the like mounted in the platform 220-1.

The driver 220-1b included in the platform 220-1 includes a bridge driver 220-1c, a virtual LAN driver 220-1d, and the like.

The bridge driver 220-1c controls the PCIe bridge controller 230. The platform 220-1 is connected to one EP mounted in the PCIe bridge controller 230 by the use of one RC. Accordingly, the platform 220-1 includes the one bridge drivers 220-1c.

The virtual LAN driver 220-1d is used in combination with the bridge driver 220-1c to perform communication with another platform through a virtual LAN line established.

The platform 220-1 is connected to the one EP mounted in the PCIe bridge controller 230 by the use of the one RC. Accordingly, the platform 220-1 includes the one virtual LAN driver 220-1d.

For example, in order to increase security, the platform 220-1 performs virtual LAN communication with another platform by the use of the virtual LAN driver 220-1d and the bridge driver 220-1c. If there is no need to increase security, then the platform 220-1 performs communication with another platform by the use of only the bridge driver 220-1c.

The OS 220-1e is basic software or a basic program for operating the platform 220-1. The bootloader 220-1f is invoked at the time of starting the platform 220-1 and is software for starting the OS 220-1e. On the platform 220-1, for example, the OS 220-1e is detected by the bootloader 220-1f and the OS 220-1e starts.

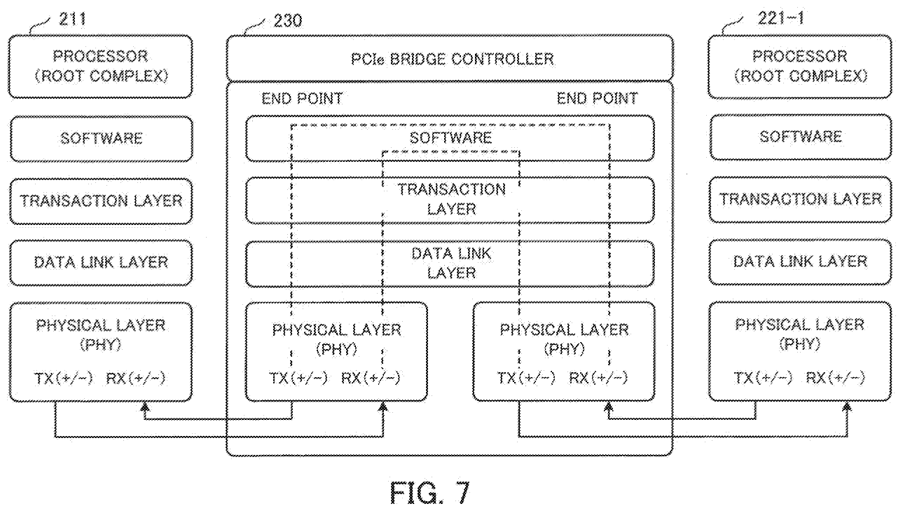

An example of a communication process performed between platforms connected to the PCIe bridge controller 230 will now be described. FIG. 7 is a view for describing an example of a communication process performed between platforms in the information processing system according to the second embodiment.

Description will be given with communication between the processor 211 of the platform 210 and the processor 221-1 of the platform 220-1 as an example.

The platform 210, which is a source, transfers data generated by the processor 211, which is an RC, through software, a transaction layer, a data link layer, and a physical layer (PHY) in order and transfers the data from the physical layer of the platform 210 to a physical layer of the PCIe bridge controller 230.

The PCIe bridge controller 230 transfers the data transferred from the platform 210 through the physical layer, a data link layer, a transaction layer, and software in order and transfers the data to an EP corresponding to an RC of the platform 220-1 by tunneling. That is to say, in the PCIe bridge controller 230, data is transferred from one RC (or a processor) to another RC (or a processor) by tunneling the data between EPs.

The platform 220-1, which is a destination, transfers the data transferred from the PCIe bridge controller 230 through a physical layer, a data link layer, a transaction layer, and software in order and transfers the data to the processor 221-1 of the platform 220-1, which is a destination.

In the information processing system 200, communication between platforms is logically established when a PCIe transaction occurs.

When data transfers from other processors are not concentrated at a specific processor connected to one of the 8 slots included in the PCIe bridge controller 230, data transfers may be performed in parallel between any different pairs of processors. For example, if the processors 221-2 and 221-3 communicate with the processor 221-1, then the PCIe bridge controller 230 processes communication by the processor 221-2 and communication by the processor 221-3 in a serial fashion.

On the other hand, if processors of different platforms communicate with one another and communications are not concentrated at a processor of a specific platform, then the PCIe bridge controller 230 may process the communications between the platforms in parallel.

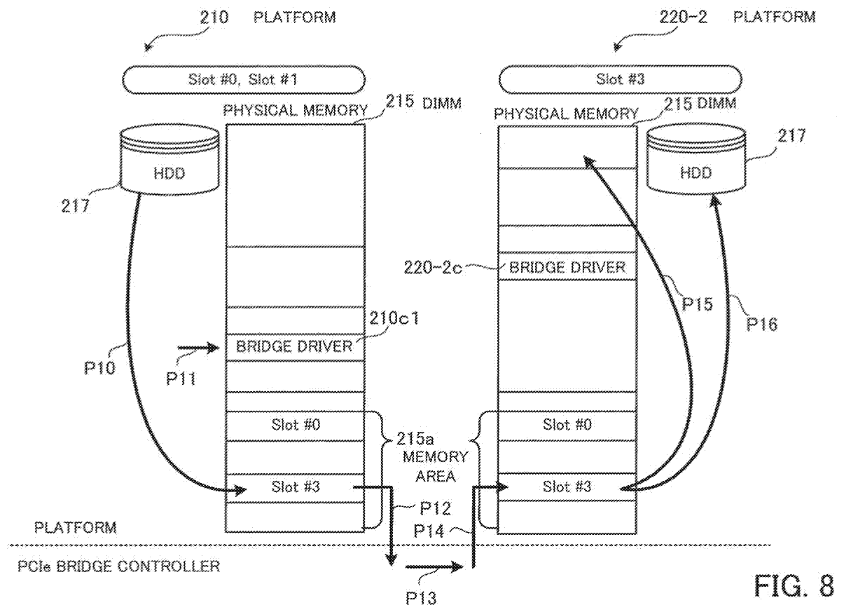

A method for transferring data between platforms via the PCIe bridge controller 230 in the information processing system 200 will now be described by the use of FIG. 8. FIG. 8 is a view for describing an example of a method for transferring data between processors via the PCIe bridge controller in the information processing system according to the second embodiment.

Description will be given with a case where data is transferred from Slot #0, out of Slot #0 and Slot #1 to which the platform 210 is connected, to the platform 220-2 connected to Slot #3 as an example.

The platform 210, which is a source, stores data (hereinafter referred to as transmission data) to be transmitted by the software or the like in a memory area 215a of the DIMM 215 or the like (that is to say, a physical memory) of the platform 210 from a storage device (that is to say, storage), such as the HDD 217, of the platform 210 (P10). The memory area 215a may be part of a communication buffer in which transmission data is temporarily stored.

The memory area 215a of the same size is set in the DIMM 215 or the like of each platform. The memory area 215a is divided according to the number of the slots 234. Each storage area obtained by dividing the memory area 215a is associated with one of the slots 234. That is to say, a storage area corresponding to each of Slots #0 through #7 is set in the memory area 215a of each platform.

For example, a storage area indicated by Slot #0 in the memory area 215a is associated with the platform 210 connected to Slot #0, and a storage area indicated by Slot #3 in the memory area 215a is associated with the platform 220-2 connected to Slot #3. The platform 210 stores the transmission data in an area assigned to a destination slot 234 (Slot #3, in this example) of the memory area 215a.

On the basis of the storage area in the memory area 215a of the platform, the bridge driver 210c1 acquires or generates slot information indicative of the destination slot 234 and address information indicative of an address of a storage area in the destination memory area 215a (P11).

In the source EP, the bridge driver 210c1 passes to the PCIe bridge controller 230 the slot information, the address information, and transfer data including the transmission data (P12). As a result, on the basis of the slot information, the PCIe bridge controller 230 connects the source slot 234 and the destination slot 234 by EP-to-EP. By doing so, the transfer data is transferred to the destination platform 220-2 (P13). On the basis of the slot information and the address information, the destination platform 220-2 stores the transmission data (or the transfer data) in an area indicated by the address information in a storage area corresponding to Slot #3 of the memory area 215a of the destination platform 220-2 (P14).

In the destination platform 220-2, a program, for example, reads out the transmission data stored in the memory area 215a and moves the data to the DIMM 215 or HDD 217 (P15 or P16).

Data are transferred in the above way from the source platform 210 to the destination platform 220-2. For example, virtual LAN communication is realized in the following way. The virtual LAN driver gives a header and the like to the transmission data stored in P10 to generate encapsulated data. The destination virtual LAN driver performs de-encapsulation to extract the original data.

As stated above, with the information processing system 200, data transfer is performed between EPs in the PCIe bridge controller 230 in place of data transfer between RCs. As a result, data transfers are realized between a plurality of RCs connected to the PCIe bridge controller 230.

That is to say, each processor is operated independently as an RC of PCIe, a device connected to each processor is connected as an EP in the PCIe bridge controller 230, and data transfer is performed between EPs. This avoids a problem caused by a device driver and enables a high-speed data transfer as one system.

Furthermore, as long as each processor has a data communication function suitable to the PCIe standard, data transfer between different processors is possible. This broadens options of a processor to be used. In this case, there is no need to worry about the presence or absence of a device driver, a supported OS, or the like.

Because each processor is connected via the PCIe bridge controller 230 which serves as an EP, there is no need to add a device driver for an RC beyond the EP. As a result, there is no need to develop the device driver and a failure caused by adding the device driver is averted.

In the information processing system 200, a prevailing processor, such as an ARM processor or an FPGA, needs to operate as an RC. Therefore, it is easily added as a processor of the information processing system 200.

In the PCIe bridge controller 230, a PCIe connection is made and PCIe communication is performed. Accordingly, a high-speed transfer which is not realized by Ethernet is realized. Furthermore, transmission and reception of high-definition video, such as 4K video or 8K video, between processors, large-scale parallel computations of big data, and the like are performed.

In addition, a dedicated processor specializing in a function, such as image processing or data retrieval, may also be connected. By doing so, a function is added or performance is improved, at low cost.

Moreover, with the information processing system 200, for example, there is no need for virtualization of the system. Accordingly, deterioration in the performance of the information processing system 200 due to virtualization is prevented. As a result, the information processing system 200 may be applied to a system for a high-load operation such as AI inference or image processing.

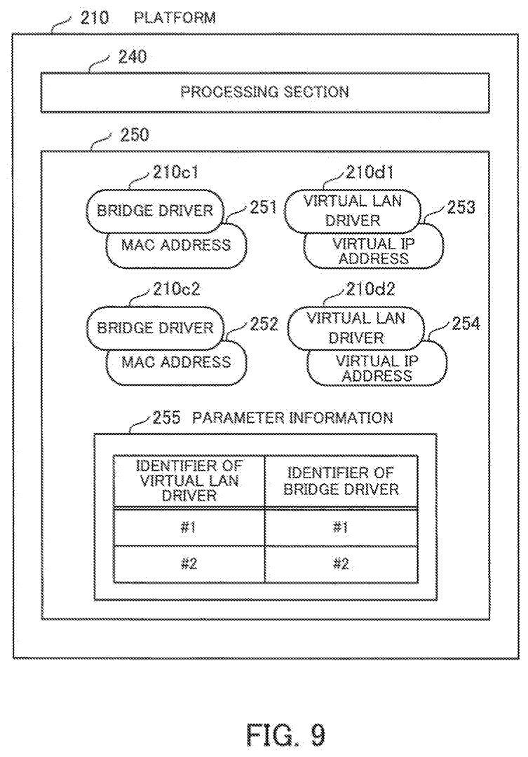

The functions of the platform 210 will now be described. FIG. 9 illustrates an example of the functional structure of the platform in the second embodiment.

The platform 210 includes a processing section 240 and a storage section 250. The processing section 240 executes various programs which the storage section 250 stores and performs various processes carried out in the various programs. The processing section 240 is realized by the processor 211. The processing section 240 is an example of the processing section 4 in the first embodiment.

For example, the processing section 240 sets parameter information 255 indicative of the correspondence between a virtual LAN driver 210d and a bridge driver 210c and associates a virtual LAN driver 210d with a bridge driver 210c on the basis of the correspondence (for example, the parameter information 255).

The storage section 250 stores various pieces of information used for the operation of various pieces of software and various programs. The storage section 250 is realized by the SSD 216, the HDD 217, or the like. The storage section 250 is an example of the storage section 3 in the first embodiment.

The storage section 250 stores media access control (MAC) addresses 251 and 252 and virtual Internet Protocol (IP) addresses 253 and 254 used for the operation of the bridge drivers 210c1 and 210c2 and the virtual LAN drivers 210d1 and 210d2, respectively, and the parameter information 255. The parameter information 255 is an example of the correspondence information 3e in the first embodiment.

The parameter information 255 indicates a bridge driver 210c with which each virtual LAN driver 210d is associated (that is to say, a bridge driver 210c paired with each virtual LAN driver 210d). The parameter information 255 is stored in a registry. Only one piece of parameter information 255 is generated in a registry regardless of the number of virtual LAN drivers 210d installed.

In the parameter information 255, an identifier of each virtual LAN driver 210d is associated with an identifier of a bridge driver 210c.

An identifier of a bridge driver 210c is identification information which is uniquely set for the bridge driver 210c and by which the bridge driver 210c is identified. An identifier of a bridge driver 210c set in the parameter information 255 is static information (that is to say, fixed information), in which restart or the like effects no change. An identifier of a bridge driver 210c set in the parameter information 255 is a unique identifier assigned, for example, at installation time and is stored in a registry.

An identifier of a virtual LAN driver 210d is identification information which is uniquely set for the virtual LAN driver 210d and by which the virtual LAN driver 210d is identified. An identifier of a virtual LAN driver 210d set in the parameter information 255 is static information (that is to say, fixed information), in which restart or the like effects no change. An identifier of a virtual LAN driver 210d set in the parameter information 255 is a unique identifier assigned, for example, at installation time and is stored in a registry.

In the example of FIG. 9, for example, a virtual LAN driver 210d having the identifier #1 is associated with a bridge driver 210c having the identifier #1. Furthermore, a virtual LAN driver 210d having the identifier #2 is associated with a bridge driver 210c having the identifier #2. Hereinafter it is assumed that the identifier #1 is set for the virtual LAN driver 210d1 and that the identifier #2 is set for the virtual LAN driver 210d2. In addition, it is assumed that the identifier #1 is set for the bridge driver 210c1 and that the identifier #2 is set for the bridge driver 210c2. That is to say, in the platform 210, it is assumed that the virtual LAN driver 210d1 is associated with the bridge driver 210c1 and that the virtual LAN driver 210d2 is associated with the bridge driver 210c2.

The MAC addresses 251 and 252 are physical addresses (node IDs, for example) set for PCIe interfaces 219. Each of the MAC addresses 251 and 252 is used for identifying a slot 234 of the PCIe bridge controller 230 to which a PCIe interface 219 is connected. Each of the MAC addresses 251 and 252 is used for data transfer by a bridge driver 210c between platforms and establishment of a virtual LAN line by a virtual LAN driver 210d between platforms.

With the information processing system 200, each of the MAC addresses 251 and 252 is generated by a bridge driver 210c according to a slot 234 to which a PCIe interface 219 is connected. That is to say, each of the MAC addresses 251 and 252 is dynamic information (that is to say, non-fixed information), which may change as a connection configuration changes.

The MAC address 251 is a physical address (physical address corresponding to Slot #0, in this example) set in the PCIe interface 219a and is generated by the bridge driver 210c1 used for controlling the PCIe interface 219a. The MAC address 251 is stored in association with the bridge driver 210c1 (for example, stored in setting information of the bridge driver 210c1).

The MAC address 252 is a physical address (physical address corresponding to Slot #1, in this example) set in the PCIe interface 219b and is generated by the bridge driver 210c2 used for controlling the PCIe interface 219b. The MAC address 252 is stored in association with the bridge driver 210c2.

Each of the virtual IP addresses 253 and 254 is used by a virtual LAN driver 210d for establishing a virtual LAN line between platforms.

With the information processing system 200, for example, each of the virtual IP addresses 253 and 254 is arbitrarily assigned by a user. That is to say, each of the virtual IP addresses 253 and 254 is dynamic information (that is to say, non-fixed information), which may change as the user changes settings.

The virtual IP address 253 is used by the virtual LAN driver 210d1 for establishing a virtual LAN line. The virtual IP address 253 is stored in association with the virtual LAN driver 210d1.

The virtual IP address 254 is used by the virtual LAN driver 210d2 for establishing a virtual LAN line. The virtual IP address 254 is stored in association with the virtual LAN driver 210d2.

As stated above, the platform 210 includes the parameter information 255 indicative of correspondence and associates a virtual LAN driver 210d with a bridge driver 210c on the basis of the parameter information 255. This enables the pairs to be fixed without being affected by restart.

In particular, the platform 210 associates in the parameter information 255 static information by which a virtual LAN driver 210d is identified with static information by which a bridge driver 210c is identified to indicate the correspondence between them. Accordingly, there is no possibility that a change in settings or the like affects the correspondence. As a result, even if the MAC address 251 or 252 changes due to a change in configuration or the virtual IP address 253 or 254 changes due to a change in settings by a user, the correspondence in the platform 210 is not affected and thus there is no need for resetting.

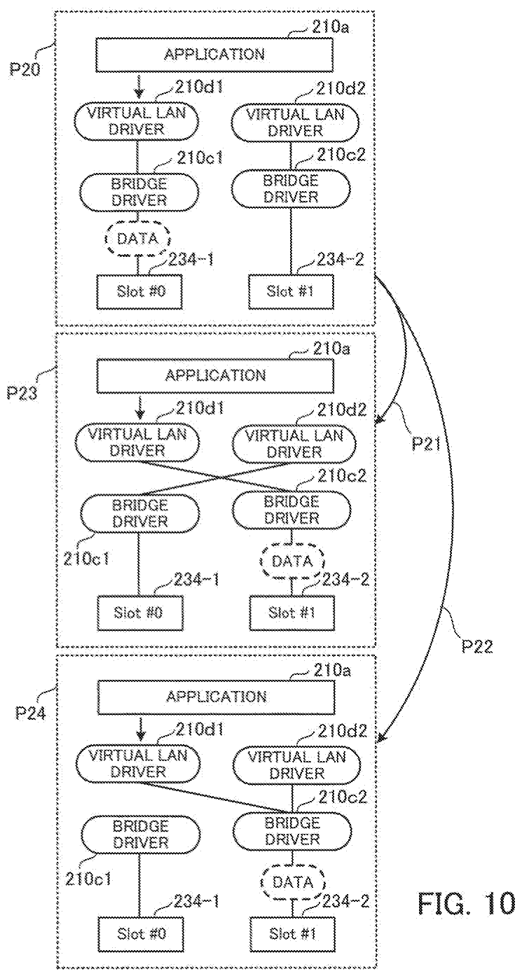

A problem which may arise in a case where a correspondence (that is to say, a pair) has changed will now be described by the use of FIG. 10. FIG. 10 is a view for describing a problem which arises in a case where a correspondence has changed in the second embodiment.

P20 of FIG. 10 indicates correspondences of a virtual LAN driver 210d and a bridge driver 210c which an application 210a recognizes. In other words, correspondences of a virtual LAN driver 210d and a bridge driver 210c illustrated in P20 of FIG. 10 are proper.

In P20, a virtual LAN driver 210d1 is associated with a bridge driver 210c1, and a virtual LAN driver 210d2 is associated with a bridge driver 210c2. That is to say, an application 210a recognizes that giving the virtual LAN driver 210d1 instructions to perform data transfer by virtual LAN communication causes the bridge driver 210c1 to output data from Slot #0. Furthermore, the application 210a recognizes that giving the virtual LAN driver 210d2 instructions to perform data transfer by virtual LAN communication causes the bridge driver 210c2 to output data from Slot #1.

If the correspondences of virtual LAN drivers 210d and bridge drivers 210c that the application 210a recognizes as described above are not fixed and restart is performed, then the correspondences may unexpectedly change (P21 or P22).

P23 of FIG. 10 illustrates an example of correspondences of a virtual LAN driver 210d and a bridge driver 210c which have unexpectedly changed (P21) from the ones the application 210a recognizes. In P23, the virtual LAN driver 210d1 is associated with the bridge driver 210c2 and the virtual LAN driver 210d2 is associated with the bridge driver 210c1. Accordingly, even if the application 210a gives instructions, on the basis of the correspondences which the application 210a recognizes, to output data from Slot #0 by virtual LAN communication, the data is outputted from Slot #1 against expectations.

P24 of FIG. 10 illustrates an example of correspondences of a virtual LAN driver 210d and a bridge driver 210c which have unexpectedly changed (P22) from the ones the application 210a recognizes. In P24, the virtual LAN driver 210d1 is associated with the bridge driver 210c2 and the virtual LAN driver 210d2 is associated with the bridge driver 210c2. Accordingly, even if the application 210a gives instructions, on the basis of the correspondences which the application 210a recognizes, to output data by virtual LAN communication, the data is inevitably outputted from Slot #1, resulting in an unexpected output behavior.

As in P23 or p24, if data is not outputted from a slot 234 which the application 210a expects due to a change in the correspondences, then the platform 210 fails to properly perform resource management.

For example, if the platform 210 gives a virtual LAN driver 210d instructions to perform data transfer by virtual LAN communication by the use of a low-load slot 234, then there is a possibility that data is outputted from a slot 234 which the platform 210 does not expect. This may lead to maldistribution of a load. As a result, the communication performance of the platform 210 deteriorates and a communication failure may occur.

On the other hand, the platform 210 stores the parameter information 255. By doing so, a bridge driver 210c with which each virtual LAN driver 210d is associated is fixed. Accordingly, there is no possibility that the correspondences change due to restart. This suppresses deterioration in the communication performance of the platform 210 and prevents the occurrence of a communication failure.

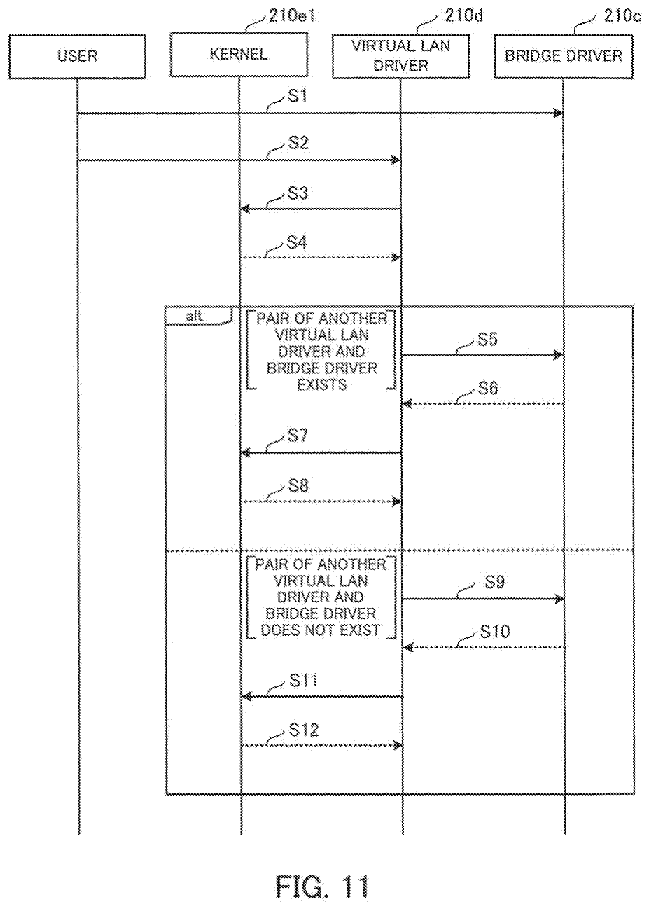

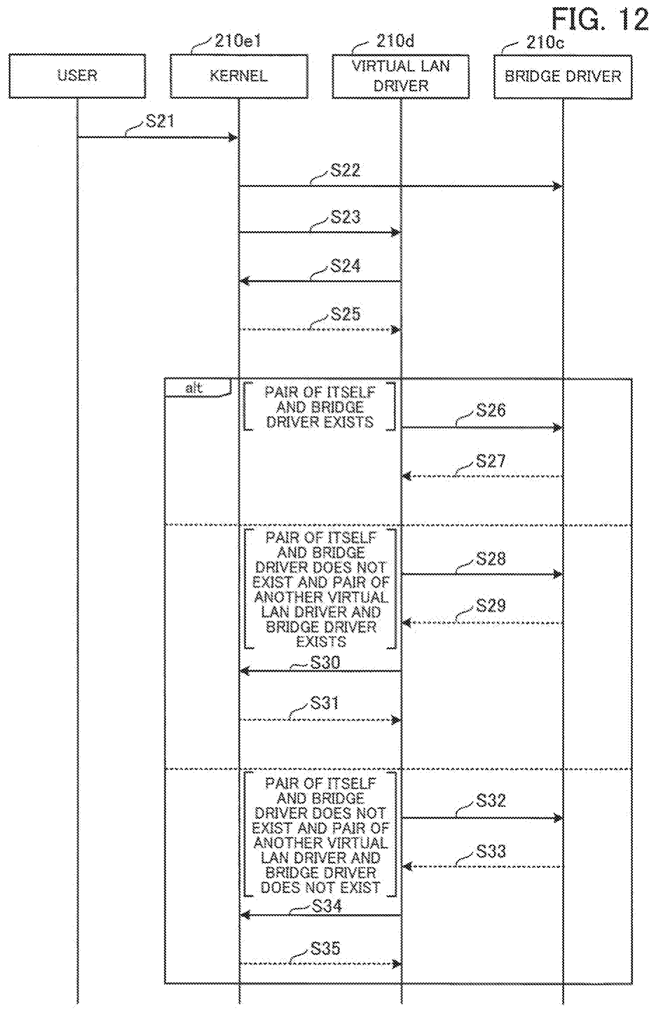

Timing of setting the parameter information 255 will now be described by the use of FIGS. 11 and 12. First, a case where the parameter information 255 is set at a time of installation will be described by the use of FIG. 11.

FIG. 11 illustrates an example of a process performed in the case where the parameter information is set at a time of installation in the second embodiment.

A kernel 210e1 is a program which is the nucleus of the OS 210e. Processes performed by various programs (specifically, the kernel 210e1, a virtual LAN driver 210d, and a bridge driver 210c) described in FIG. 11 are performed by the processing section 240.

On the basis of instructions from a user to install bridge drivers 210c, each bridge driver 210c is installed before virtual LAN drivers 210d (S1). After the installation of each bridge driver 210c ends, the installation of the virtual LAN drivers 210d is initiated on the basis of instructions from the user to install the virtual LAN drivers 210d (S2).

The virtual LAN driver 210d demands from the kernel 210e1 the parameter information 255 stored in a registry (S3) and acquires the parameter information 255 (in this case, a duplicate of the parameter information 255 stored in the registry) (S4).

The virtual LAN driver 210d determines whether or not a pair of another virtual LAN driver 210d and a bridge driver 210c is already set in the parameter information 255. If the virtual LAN driver 210d is the first virtual LAN driver 210d installed, then the virtual LAN driver 210d determines that a pair of another virtual LAN driver 210d and a bridge driver 210c is not set in the parameter information 255. If the virtual LAN driver 210d is the second or subsequent virtual LAN driver 210d installed, then the virtual LAN driver 210d determines that a pair of another virtual LAN driver 210d and a bridge driver 210c is set in the parameter information 255.

If the virtual LAN driver 210d determines that a pair of another virtual LAN driver 210d and a bridge driver 210c is set in the parameter information 255, then the virtual LAN driver 210d specifies bridge drivers 210c yet to be paired with another virtual LAN driver 210d. The virtual LAN driver 210d makes a link request (that is to say, a pairing request) to one of the specified bridge drivers 210c yet to be paired with another virtual LAN driver 210d (S5).

The virtual LAN driver 210d accepts permission for the link request (S6). The virtual LAN driver 210d requests the kernel 210e1 to set its identifier in association with an identifier of the bridge driver 210c from which the permission is accepted in the parameter information 255 stored in the registry (S7). The virtual LAN driver 210d accepts a response to the effect that setting in the parameter information 255 stored in the registry is completed (S8). After that, subsequent processes at the time of installing the virtual LAN driver 210d are performed (for example, another virtual LAN driver 210d is installed).

On the other hand, if the virtual LAN driver 210d determines that a pair of another virtual LAN driver 210d and a bridge driver 210c is not set in the parameter information 255, then the virtual LAN driver 210d makes a link request to an arbitrary bridge driver 210c (S9).

The virtual LAN driver 210d accepts permission for the link request (S10). The virtual LAN driver 210d requests the kernel 210e1 to set its identifier in association with an identifier of the bridge driver 210c from which the permission is accepted in the parameter information 255 stored in the registry (S11). The virtual LAN driver 210d accepts a response to the effect that setting in the parameter information 255 stored in the registry is completed (S12). After that, subsequent processes at the time of installing the virtual LAN driver 210d are performed.

By doing so, the processing section 240 which performs the processes performed by the various programs associates a virtual LAN driver 210d which is being installed with a bridge driver 210c yet to be paired and sets their correspondence in the parameter information 255.

As a result, the processing section 240 prevents a plurality of virtual LAN drivers 210d from being associated with one bridge driver 210c.

Next, a case where the parameter information 255 is set at a time of start will be described by the use of FIG. 12. FIG. 12 illustrates an example of a process performed in the case where the parameter information is set at a time of start in the second embodiment.

Processes performed by various programs (specifically, the kernel 210e1, a virtual LAN driver 210d, and a bridge driver 210c) described in FIG. 12 are performed by the processing section 240.

When the kernel 210e1 accepts instructions from a user to start virtual LAN drivers 210d (S21), the kernel 210e1 starts each bridge driver 210c before starting the virtual LAN drivers 210d (S22). After the start of each bridge driver 210c ends, the kernel 210e1 begins to start the virtual LAN drivers 210d (S23).

The virtual LAN driver 210d demands from the kernel 210e1 the parameter information 255 stored in the registry (S24) and acquires the parameter information 255 (S25).

The virtual LAN driver 210d determines whether or not there is a pair of itself and a bridge driver 210c in the parameter information 255. A pair is set at installation time in the parameter information 255. For example, if there is no bridge driver 210c to be paired with at installation time, then there may be no pair of itself and a bridge driver 210c.

If the virtual LAN driver 210d determines that there is a pair of itself and a bridge driver 210c, then the virtual LAN driver 210d makes a link request to the paired bridge driver 210c (S26). After the virtual LAN driver 210d accepts permission for the link request (S27), subsequent processes at the time of starting the virtual LAN driver 210d are performed (for example, another virtual LAN driver 210d is started).

On the other hand, if the virtual LAN driver 210d determines that there is no pair of itself and a bridge driver 210c, then the virtual LAN driver 210d determines whether or not a pair of another virtual LAN driver 210d and a bridge driver 210c is already set in the parameter information 255.

If the virtual LAN driver 210d determines that a pair of another virtual LAN driver 210d and a bridge driver 210c is set in the parameter information 255, then the virtual LAN driver 210d specifies bridge drivers 210c yet to be paired with another virtual LAN driver 210d. The virtual LAN driver 210d makes a link request to one of the specified bridge drivers 210c yet to be paired with another virtual LAN driver 210d (S28).

The virtual LAN driver 210d accepts permission for the link request (S29). The virtual LAN driver 210d requests the kernel 210e1 to set its identifier in association with an identifier of the bridge driver 210c from which the permission is accepted in the parameter information 255 stored in the registry (S30). The virtual LAN driver 210d accepts a response to the effect that setting in the parameter information 255 stored in the registry is completed (S31). After that, subsequent processes at the time of starting the virtual LAN driver 210d are performed.

If the virtual LAN driver 210d determines that a pair of another virtual LAN driver 210d and a bridge driver 210c is not set in the parameter information 255, then the virtual LAN driver 210d makes a link request to an arbitrary bridge driver 210c (S32).

The virtual LAN driver 210d accepts permission for the link request (S33). The virtual LAN driver 210d requests the kernel 210e1 to set its identifier in association with an identifier of the bridge driver 210c from which the permission is accepted in the parameter information 255 stored in the registry (S34). The virtual LAN driver 210d accepts a response to the effect that setting in the parameter information 255 stored in the registry is completed (S35). After that, subsequent processes at the time of starting the virtual LAN driver 210d are performed.

As described above, the processing section 240 which performs the processes performed by the various programs associates a virtual LAN driver 210d at first start time with a bridge driver 210c yet to be paired and sets their correspondence in the parameter information 255.

As a result, the processing section 240 prevents a plurality of virtual LAN drivers 210d from being associated with one bridge driver 210c.

The processes in FIG. 11 or 12 performed by the kernel 210e1, the virtual LAN driver 210d, and the bridge driver 210c are taken as an example and are not limited to those described. That is to say, as long as the processing section 240 which executes various programs (for example, a virtual LAN driver 210d and a bridge driver 210c) performs the processes, for example, another program may perform part or all of the processes of which the various programs are in charge. For example, the processes performed at installation time by the virtual LAN drivers 210d may be performed by an installer program executed by the processing section 240. For example, if an installer program is used for realizing the processes, then the processes (S9 through S12) performed by the first virtual LAN driver 210d and the processes (S5 through S8) performed by the second and subsequent virtual LAN drivers 210d may be described independently in the installer program.

Furthermore, an installer program may give instructions to install a bridge driver 210c or instructions to install a virtual LAN driver 210d, in place of a user.

In addition, in the description of FIG. 11, each bridge driver 210c is installed first at installation time. However, another case is possible. For example, bridge drivers 210c and virtual LAN drivers 210d may be installed alternately.

The disclosed technique is not limited to the above embodiments. The disclosed technique may be variously modified and implemented in a range which does not depart from the spirit of the embodiments. Each configuration or process in the embodiments may be adopted, rejected, or selected at need or may properly be combined.

In the above embodiment, by way of example, the case where the platform 210 is connected to the PCIe bridge controller 230 by the use of the two RCs is described. However, the platform 210 may be connected to the PCIe bridge controller 230 by the use of three or more RCs. Furthermore, in the configuration illustrated in FIG. 5, the PCIe bridge controller 230 includes the eight slots 234-1 through 234-8 as an example. However, a configuration of the PCIe bridge controller 230 is not limited to that illustrated in FIG. 5. The configuration of the PCIe bridge controller 230 illustrated in FIG. 5 may variously modified and implemented. That is to say, the PCIe bridge controller 230 may include seven slots 234 or fewer or nine slots 234 or more. In addition, in the configuration illustrated in FIG. 3, for example, each of the plurality of platforms (for example, the platforms which function as an operation section) may be connected to an EP of the PCIe bridge controller 230 by the use of two RCs or more.

Furthermore, in the above embodiment the communication system using PCIe is described. However, the present disclosure is not limited to a communication system using PCIe. The present disclosure may be applied to communication based on a communication standard other than PCIe.

In the above embodiment the description is given with PCIe as an example of an input/output (I/O) interface of each component. However, an I/O interface of each component is not limited to PCIe. For example, an I/O interface of each component may use any technique as long as data transfer is performed between a device (for example, a peripheral controller) and a processor via a data transfer bus. The data transfer bus may be a general-purpose bus via which a high-speed data transfer is performed in a local environment created in one enclosure or the like (for example, in one system or device). An I/O interface may be a parallel interface or a serial interface.

In case of serial transfer, an I/O interface may have a configuration in which a point-to-point connection is made and in which data are transferred on a packet basis. In case of serial transfer, an I/O interface may include a plurality of lanes. A layer structure of an I/O interface may have a transaction layer for generating and decoding a packet, a data link layer for performing error detection and the like, and a physical layer for making serial-parallel conversion and parallel-serial conversion. Furthermore, an I/O interface may include a root complex at the top of the hierarchy having one or more ports, an end point which is an I/O device, a switch for increasing the number of ports, a bridge which converts a protocol, and the like. An I/O interface may use a multiplexer for multiplexing data and a clock signal to be transmitted. In this case, the reception side may use a demultiplexer for separating the data from the clock signal.

According to an aspect, the occurrence of a communication failure is prevented.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a first communication device connected to another apparatus via an expansion bus so as to perform communication;
a second communication device connected to said another apparatus via the expansion bus so as to perform communication;
a memory which stores a first communication program that controls communication with said another apparatus by the first communication device via the expansion bus, a second communication program that controls communication with said another apparatus by the second communication device via the expansion bus, a first processing program and a second processing program that perform a determined process on data and that cause an associated one of the first communication program and the second communication program to transmit to said another apparatus the data on which the determined process has been performed, and correspondence information including a first identifier indicative of a first corresponding communication program, of the first communication program and the second communication program, associated with the first processing program and a second identifier indicative of a second corresponding communication program, of the first communication program and the second communication program, associated with the second processing program; and
a processor which determines the first corresponding communication program from the first communication program and the second communication program, which sets in the correspondence information an identifier indicative of the determined first corresponding communication program as the first identifier, which determines the second corresponding communication program from the first communication program and the second communication program, and which sets in the correspondence information an identifier indicative of the determined second corresponding communication program as the second identifier.

2. The information processing apparatus according to claim 1, wherein the processor:
determines the first corresponding communication program from the first communication program and the second communication program and sets in the correspondence information the identifier indicative of the determined first corresponding communication program as the first identifier, at a time of installing the first processing program; and
determines the second corresponding communication program from the first communication program and the second communication program and sets in the correspondence information the identifier indicative of the determined second corresponding communication program as the second identifier, at a time of installing the second processing program.

3. The information processing apparatus according to claim 2, wherein the processor installs the first processing program and the second processing program after the processor installs the first communication program and the second communication program.

4. The information processing apparatus according to claim 2, wherein the processor installs the first communication program, the first processing program, the second communication program, and the second processing program in that order.

5. The information processing apparatus according to claim 1, wherein the processor:
determines the first corresponding communication program from the first communication program and the second communication program and sets in the correspondence information the identifier indicative of the determined first corresponding communication program as the first identifier, at a time of starting the first processing program for a first time after installing the first processing program; and
determines the second corresponding communication program from the first communication program and the second communication program and sets in the correspondence information the identifier indicative of the determined second corresponding communication program as the second identifier, at a time of starting the second processing program for a first time after installing the second processing program.

6. The information processing apparatus according to claim 5, wherein the processor starts the first processing program and the second processing program after the processor starts the first communication program and the second communication program.

7. The information processing apparatus according to claim 1, wherein when the processor determines the first corresponding communication program from the first communication program and the second communication program and one of the first communication program and the second communication program is associated with the second processing program, the processor sets in the correspondence information an identifier indicative of another one of the first communication program and the second communication program as the first identifier.

8. An information processing system comprising:
a relay device which includes an expansion bus and relays communication via the expansion bus;
a plurality of processor modules each of which is connected to the expansion bus; and
an information processing apparatus connected to the expansion bus, the information processing apparatus including:
a first communication device connected via the expansion bus to the plurality of processor modules so as to perform communication;
a second communication device connected via the expansion bus to the plurality of processor modules so as to perform communication;
a memory which stores a first communication program that controls communication with the plurality of processor modules by the first communication device via the expansion bus, a second communication program that controls communication with the plurality of processor modules by the second communication device via the expansion bus, a first processing program and a second processing program that perform a determined process on data and that cause an associated one of the first communication program and the second communication program to transmit to the plurality of processor modules the data on which the determined process has been performed, and correspondence information including a first identifier indicative of a first corresponding communication program, of the first communication program and the second communication program, associated with the first processing program and a second identifier indicative of a second corresponding communication program, of the first communication program and the second communication program, associated with the second processing program; and
a processor that determines the first corresponding communication program from the first communication program and the second communication program, that sets in the correspondence information an identifier indicative of the determined first corresponding communication program as the first identifier, that determines the second corresponding communication program from the first communication program and the second communication program, and that sets in the correspondence information an identifier indicative of the determined second corresponding communication program as the second identifier.

9. A non-transitory computer-readable storage medium storing a computer program that causes a computer to execute a process comprising:
determining a first corresponding communication program from a first communication program and a second communication program;
setting in correspondence information an identifier indicative of the determined first corresponding communication program as a first identifier;
determining a second corresponding communication program from the first communication program and the second communication program; and
setting in the correspondence information an identifier indicative of the determined second corresponding communication program as a second identifier,
wherein the computer includes:
a first communication device connected to another apparatus via an expansion bus so as to perform communication;
a second communication device connected to said another apparatus via the expansion bus so as to perform communication; and
a memory which stores the first communication program that controls communication with said another apparatus by the first communication device via the expansion bus, the second communication program that controls communication with said another apparatus by the second communication device via the expansion bus, a first processing program and a second processing program that perform a determined process on data and that cause an associated one of the first communication program and the second communication program to transmit to said another apparatus the data on which the determined process has been performed, and the correspondence information including the first identifier indicative of the first corresponding communication program, of the first communication program and the second communication program, associated with the first processing program and the second identifier indicative of the second corresponding communication program, of the first communication program and the second communication program, associated with the second processing program.
